(19) United States
(12) Patent Application Publication
(10) Pub. No.: US 2012/0155399 A1
(43) Pub. Date: Jun. 21, 2012

(54) CHANNEL ALLOCATION METHOD IN MULTI-CHANNEL COGNITIVE RADIO NETWORK

(75) Inventors: Franklin A. ANTONY, Daejeon-si (KR); Myung Sun Song, Daejeon-si (KR); Jin Suk Pak, Daejeon-si (KR); Marwan M. Krunz, Tucson, AZ (US); Tao Shu, Auburn Hills, MI (US)

(73) Assignees: SmartNet Communications LLC, Tucson, AZ (US); ELECTRONICS AND TELECOMMUNICATIONS RESEARCH INSTITUTE, Daejeon-si (KR)

(21) Appl. No.: 13/314,792

(22) Filed: Dec. 8, 2011

(30) Foreign Application Priority Data
Dec. 8, 2010 (KR) 10-2010-0125187

(51) Int. Cl. H04W 72/04

(52) U.S. Cl. 370/329

(57) ABSTRACT

A method of allocating channels to jobs requiring a channel allocation is provided using a sequential channel allocation method, a batch channel allocation method, or a channel allocation method including the sequential channel allocation method and the batch channel allocation method in a multi-channel cognitive radio network. As a result, it is possible to rapidly and optimally allocate channels to jobs requiring the channel allocation in the multi-channel CR network and to efficiently manage the network by minimizing the number of operational channels.

### CROSS-REFERENCE TO RELATED APPLICATIONS

This application claims the benefit of priority of Korean Patent Application No. 10-2010-0125187 filed on Dec. 8, 2010, which is incorporated by reference in their entirety herein.

### BACKGROUND

1. Field of the Invention

The present invention relates to a cognitive radio network technique, and more particularly, to a time-efficient radio resource management method in a multi-channel cognitive radio network.

2. Description of the Related Art

One prominent issue in the radio communication technology is how to use radio frequencies in the situation where radio frequency resources are finite but the number of users thereof increases.

Most personal short-distance radio devices utilize public frequency bands. However, the most public frequency bands which can be utilized by the personal short-distance radio devices are unlicensed and are finite. The other frequency bands have to be licensed and most thereof are assigned to particular usages.

Under this radio communication environment, it is difficult to provide satisfactory communication quality to the increasing radio communication users. Since new types of devices and new communication services have appeared, it is an important issue how to assign finite radio resources.

In order to solve such a problem, it is necessary to consider a method of enhancing a utilization efficiency of radio frequency resources or efficiently assigning the radio frequency resources.

One of prominent techniques of utilizing unused radio spectrums in a given geographical location is the cognitive radio (hereinafter, referred to as “CR”) technique.

### SUMMARY

An advantage of some aspects of the invention is that it provides a method of efficiently managing a multi-channel cognitive radio network by minimizing the number of operational channels in the network.

Another advantage of some aspects of the invention is that it provides a method of rapidly and optimally allocating channels in a multi-channel cognitive radio network.

Still another advantage of some aspects of the invention is that it provides a method of performing an online radio resource management in a multi-channel cognitive radio network.

According to an aspect of the invention, there is provided a sequential channel allocation method in a multi-channel cognitive radio network, including the steps of: detecting operational channels in the network and constructing an operational channel set; detecting the number of unused unit radio resources and the number of unit radio resources necessary for processing a job for each channel of the operational channel set; and assigning the job to the channel in which the number of unused unit radio resources is equal to the number of unit radio resources necessary for processing the job or the number of unused unit radio resources is greater than the number of unit radio resources necessary for processing the job among the channels of the operational channel set.

At this time, when the number of unused unit radio resources is equal to the number of unit radio resources necessary for processing the job or the number of unused unit radio resources is greater than the number of unit radio resources necessary for processing the job in the plurality of channels of the operational channel set, the job may be assigned to the channel in which the number of unit radio resources necessary for processing the job is minimized among the plurality of channels.

When a channel in which the number of unused unit radio resources is equal to the number of unit radio resources necessary for processing the job or the number of unused unit radio resources is greater than the number of unit radio resources necessary for processing the job does not exist in the operational channel set, the job may be allocated to a channel in which the number of unused unit radio resources is equal to the number of unit radio resources necessary for processing the job or the number of unused unit radio resources is greater than the number of unit radio resources necessary for processing the job among channels other than the operational channel set. In this case, when the number of corresponding channels is two or more, the job may be assigned to the channel in which the number of unit radio resources necessary for processing the job is minimized among the plurality of channels.

According to another aspect of the invention, there is provided a batch channel allocation method in a multi-channel cognitive radio network, including the steps of constructing a predetermined channel set; detecting a capacity of each channel of the channel set; assigning jobs requiting a channel allocation to the channels of the channel set; determining whether a channel to which the jobs are assigned more than the capacity of the channel exists for all the channels of the channel set; and performing the step of assigning the jobs to the channels and the subsequent steps again when it is determined that a channel to which the jobs are assigned more than the capacity of the channel exists, and allocating the channels in accordance with the job assignment when it is determined that a channel to which the jobs are assigned more than the capacity of the channel does not exist.

At this time, the channel set may be a set of operational channels in the network.

Here, the step of determining whether a channel to which the jobs are assigned more than the capacity of the channel exists may include determining whether an amount of radio resources necessary for processing the total jobs and assigned to the channels of the channel set is greater than an amount of available radio resources.

The batch channel allocation method may further include a step of determining whether the assignment minimizes the number of channels in use of the channel set when it is determined that a channel to which the jobs are assigned more than the capacity of the channel does not exist. In this case, the channels may be allocated in accordance with the job assignment when it is determined the assignment minimizes the number of channels in use, and the step of assigning the jobs to the channels and the subsequent steps may be performed again when it is determined that the assignment does not minimize the number of channels in use.

The batch channel allocation method in the multi-channel cognitive radio network may be performed when a request to allocate a channel to a job is received or when a job in process is finished.

In the batch channel allocation method in the multi-channel cognitive radio network, the assignment of the jobs to the channels of the channel set may be performed using a tree structure. The tree structure may be constructed so that the height of the tree structure corresponds to the number of jobs requiring the channel allocation, nodes located at the same height in the tree structure correspond to the same job out of the jobs requiring the channel allocation, and edges of the tree structure correspond to the channels which can be allocated to the jobs corresponding to the nodes from which the edges originate among the channels of the channel set. It may be determined whether the channel allocation is feasible from the top to the bottom and from the left to the right in the tree structure.

The leftmost edge of the edges branched from a specific node in the tree structure may correspond to the channel with the best channel quality and the higher nodes of the nodes in the tree structure may correspond to the jobs requiring a large amount of radio resources.

When the channel allocation to a new job is requested, new leaf nodes of the tree structure may be constructed by the nodes corresponding to the new job. When an existing channel allocation is currently feasible, a search may be started from the node corresponding to the current channel allocation and a new channel allocation may be setup. When a new channel allocation is not set up, a new channel may be added to the channel set to reconstruct the edges of the tree structure and the new channel allocation may be set up in the reconstructed tree structure.

According to still another aspect of the invention, there is provided a channel allocation method in a multi-channel cognitive radio network, including the steps of detecting operational channels in the network and constructing an operation channel set; performing a sequential channel allocation on a necessary job requiring a channel allocation using the channels of the operational channel set; and performing a batch channel allocation on the overall jobs including the necessary job using the channels of the operational channel set when the channel to be allocated to the necessary job is not searched for by the sequential channel allocation. Here, the sequential channel allocation includes the steps of: determining whether the necessary job exceeds the capacity of the channel to be allocated to the necessary job for each channel of the operational channel set; and determining that the channel to be allocated to the necessary job is not searched for when it is determined that a channel in which the necessary job does not exceed the capacity of the channel does not exist in the channels of the operational channel set, and assigning the necessary job to an available channel when the available channel in which the necessary job does not exceed the capacity exists. The batch channel allocation includes the steps of detecting the capacity of each channel of the operational channel set; assigning the overall jobs including the necessary job to the channels of the operational channel set and determining whether a channel to which the jobs are assigned more than the capacity of the channel exists; and performing the step of assigning the jobs to the channels and the subsequent steps again when it is determined that the channel to which the jobs are assigned more than the capacity of the channel exists, and allocating the channels in accordance with the job assignment when it is determined that the channel to which the jobs are assigned more than the capacity of the channel does not exist.

When the channels to which the overall jobs should be assigned are not set up by the batch channel allocation, a new channel may be added to the operational channel set and the sequential channel allocation may be performed on the necessary job.

At this time, when two or more available channels exist at the time of performing the sequential channel allocation, the necessary job may be assigned to the channel requiring the smallest amount of radio resources for processing the necessary job among the two or more available channels.

The channel allocation method may further include a step of determining whether the job assignment minimizes the number of channels in use among the channels of the channel set when the channel to which the jobs are assigned more than the capacity of the channel does not exist at the time of performing the back channel allocation. In this case, the channels may be allocated in accordance with the job assignment when it is determined that the job assignment minimizes the number of channels in use, and the step of assigning the overall jobs to the channels and determining whether a channel to which the jobs are assigned more than the capacity of the channel exists and the subsequent steps may be performed again when it is determined that the job assignment does not minimize the number of channels in use.

According to the above-mentioned configurations, it is possible to efficiently manage a multi-channel cognitive radio network by minimizing the number of operational channels in the network.

It is also possible to rapidly and optimally allocate channels in the multi-channel cognitive radio network.

It is also possible to perform an online radio resource management in the multi-channel cognitive radio network.

### BRIEF DESCRIPTION OF THE DRAWINGS

FIGS. 1 and 2 are diagrams schematically illustrating an MSJA problem.

FIG. 3 is a flow diagram schematically illustrating a method of fining an optimal solution to an RMSJA problem.

FIG. 4 is a flow diagram schematically illustrating a sequential channel allocation method.

FIG. 5 is a flow diagram schematically illustrating a channel allocation method in which a sequential method and a batch method are combined.

FIG. 6 is a diagram schematically illustrating a tree structure used in a batch channel allocation method.

FIG. 7 is a diagram schematically illustrating a tree structure when a new flow requests joining a subnet.

FIG. 8 is a diagram schematically illustrating a method of searching a tree structure constructed for a new flow.

### DESCRIPTION OF EXEMPLARY EMBODIMENTS

With the development of various communication techniques for various radio spectrums, the radio spectrums are not sufficient for new communication systems. However, frequencies for different communication techniques are not completely utilized. Available channels in a CR network vary with the elapse of time depending on geometrical locations. In order to efficiently utilize frequency resources, the CR technique provides a method of opportunistically selecting and utilizing radio resources less utilized in a given geometrical location.

The radio resource management in the CR network is different from that in the past communication networks. The TV band is one of prominent radio frequency resources to which cognitive communication is applied so as to utilize radio resources. The TV band is a frequency band which is less utilized in the most geographical locations, particularly, in rural areas. The TV band which is less utilized can be utilized by opportunistically selecting free channels in a given geographical location. However, the operation of an incumbent user (hereinafter, referred to as “IU”), that is, a user licensed to utilize a specific frequency band, of utilizing the specific frequency band should be protected. For example, a secondary user (hereinafter, referred to as “SU”)'s operation of utilizing the specific frequency band should not interfere with the IU's operation of utilizing the specific frequency band for analog TVs, digital TVs, and mobile phones.

The cognitive functionality in the CR system provides a mechanism for protecting the IU. Another important issue which should be considered in the CR network is radio resource management (RRM). The efficient utilization of available radio resources improves the total performance of the CR network in terms of the throughput.

The quality of service (hereinafter, referred to as “QoS”) is an important research issue in communication systems employing a multimedia streaming application. The QoS required for a multimedia call can be acquired through the use of resource reservation and call admission processes.

The invention provides a call admission process and a radio resource reservation process for a multimedia streaming call requiring a different bandwidth. Users require some bandwidths for supporting the multimedia streaming. The QoS supporting a call is provided through the use of a call admission control (CAC) of determining whether the call could be admitted by a system. The call is admitted when a frequency band for the requested call can be guaranteed, and the call is rejected otherwise.

The invention can be applied to any CR network in which an operation should be protected. The invention is time-efficient so that it can be applied to an online RRM.

The invention can be put into practice in a CR network operating in a UHF band based on ECMA 392, IEEE 802.11af, and the like for multimedia streaming applications under environment of homes or offices. The invention operates in a master-slave mode based on the CR network so as to utilize unused UHF TV channels through the use of an opportunistic access.

Whenever an IU appears in an operating channel, a CR device should release the channel and move to another unused channel so as to protect the IU.

The invention provides a radio resource management method in a multi-channel CR network in which the CAC is performed in accordance with the call admission process to allocate radio resources in a system.

In a CR network, the number of available channels in a given geometrical location varies with the elapse of time. A CR system searches for available free channels through the use of a spectrum sensing technique and an access to an IU database.

The available channels have to be efficiently utilized by plural users sharing the channels. In order to effectively utilize the available channels, it is necessary to minimize the number of channels available in the CR system.

In the multimedia streaming application, the CAC is an important mechanism for guaranteeing the QoS of a multimedia call. If a call is once admitted through the use of the CAC, a requested band should be available in the duration of the call. Otherwise, the minimum QoS of the call is not satisfied.

Two important issues to be considered for efficiently utilizing the CR network are a CAC algorithm and a radio resource reservation algorithm. When the CAC algorithm and the radio resource reservation algorithm are carried out online, the execution complexity of the algorithms should also be taken into consideration.

Hereinafter, an embodiment of the invention will be described in detail with reference to the accompanying drawings. An exhaustive search method in this specification is a search method batch used in a batch channel allocation method and means to perform all or a part of the batch channel allocation method. In this specification, a flow and a stream have the same meaning and represents a job assigned to a channel and carried out through the channel.

### <Radio Resource Management as Multi-server Job Assignment Problem>

A radio resource management function is optimized in terms of minimizing the number of operating channels. Basically, this function can be modeled using a so-called multi-server job assignment (MSJA) problem.

The following mappings are introduced for the explanation.

1. S={s₁, . . . , s_{M}} is defined as a set of servers in a network and means a set of available channels C. The capacity of each server sⱼ is defined as Cⱼ (which is the number of media access slots (MASs) per super frame).

2. A set of jobs J={j₁, . . . , j_{N}} is constructed by a set of ongoing (already admitted) flows and a prospective flow requesting for admission.

3. tₘₙ represents the minimum number of MASs required for supporting a rate requirement of flown over channel m. That is, tₘₙ means an amount of work (service) that job jₙ requires from server sₘ. The value of tₘ can be calculated from the flow requirement and the maximum data rate which can be supported by channel m for flow n. When channel m is unavailable for flow n due to an IU's operation, tₙₘ=∞ can be set. All m in the range of 1≦m≦M satisfies tₘₙ≦Cₘ. T=[tₘₙ] is defined as an M×N resource consumption matrix.

4. Each server can execute a job at a time. If the server starts executing a job, the server will not stop until it finishes executing the job. The server can start executing a next job only after it finishes executing the current job. A job cannot be split and executed by two or more servers. That is, a job is assigned to only one server.

It should be noted that the amount of service required by a job can vary depending on the servers. It should also be noted that the relative efficiency of the servers for a job can vary depending on the type of job. Accordingly, if a server (channel) can rapidly execute a job (flow) (if the channel is suitable for the flow), it does not mean that the same server can execute other jobs (flows) similarly.

A feasible assignment of a job to a server means that the total number of slots required by the job is not larger than the capacity of the server. In other words, when a job assigned to server sₘ is defined as Jₘ, Jₘ⊂J is established. Then, the assignment to server sₘ is feasible only when Expression 1 is satisfied.

$$\begin{matrix}Expression 1 & \\ {\sum }_{n ∈ {j}_{m}} {t}_{mn} \leq {C}_{m} & \end{matrix}$$

The assignment is feasible only when the following three conditions are satisfied.

$$\begin{matrix}Expression 2 & \\ {\sum }_{n ∈ {J}_{m}} {t}_{mn} \leq {C}_{m} , ∀ m , 1 \leq m \leq M & ( 1 ) \\ {J}_{u} ⋂ {J}_{v} = ∅ , ∀ u , v with 1 \leq u \leq M , 1 \leq v \leq M , u \neq v & ( 2 ) \\ {\sum }_{m = 1}^{M} {J}_{m} = J & ( 3 )\end{matrix}$$

The condition of (2) means that no flow is assigned to two or more servers.

Binary variable xₘ for sₘ can be defined by Expression 3.

$$\begin{matrix}Expression 3 & \\ {x}_{m} = \{ \begin{matrix}0 ; & if \vert Jm \vert = 0 \\ 1 ; & if \vert Jm \vert \geq 1\end{matrix} & \end{matrix}$$

Here, the goal of minimizing the total number of servers allocated to jobs can be expressed by Expression 4.

$$\begin{matrix}Expression 4 & \\ minimize {\sum }_{m = 1}^{M} {x}_{m} & \end{matrix}$$

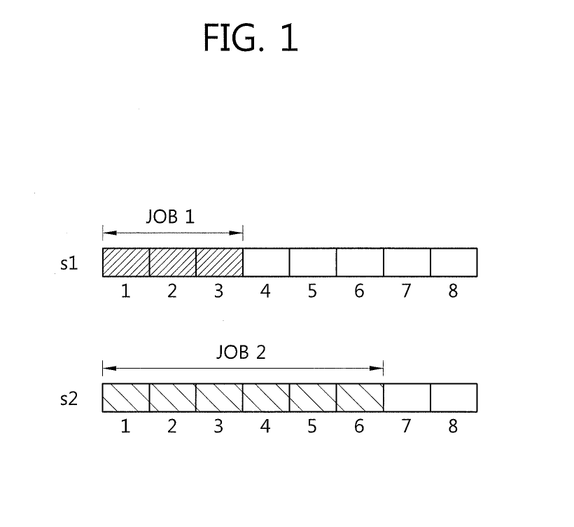

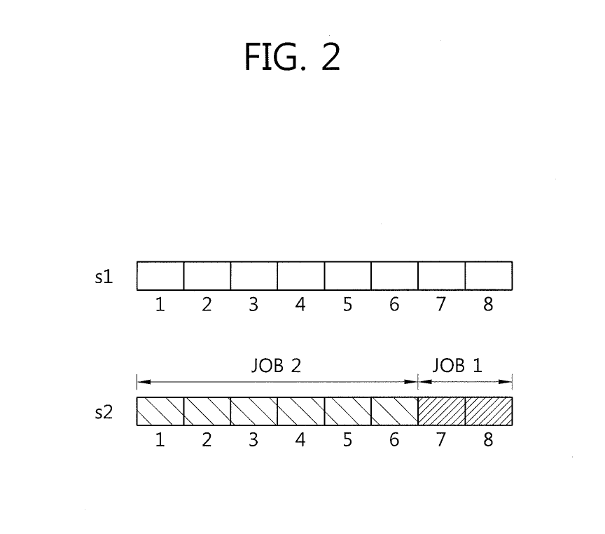

FIGS. 1 and 2 are diagrams schematically illustrating an example of the MSJA problem.

In FIGS. 1 and 2, M is 2 and N is 2. For the purpose of convenient explanation, it is assumed that the capacity of each server is 8 slots, t₁₁ is 3 slots, t₂₁ is 2 slots, and t₁₂ and t₂₂ are 6 slots.

When job 1 is first assigned to server s₁, job 2 should be assigned to server s₂. This is because when job 1 and job 2 are assigned to a server, 9 slots are required which exceeds the capacity of the server. Accordingly, the total number of servers required for supporting two jobs is 2 (see FIG. 1). On the other hand, a better assignment is accomplished if both jobs are assigned to server s₂, because only one server is allocated to the jobs (see FIG. 2).

Here, two remarks should be noted.

1. It should be noted that the MSJA problem may not have a feasible solution. In this case, the request may be rejected.

More conservation criteria may be also be employed for the call admission control. For example, when the optimal feasible solution is to utilize a predetermined number of channels, a prospective stream may be rejected. Here, the predetermined number can be set in advance at the time of constructing a system.

It may be required that the feasible assignment cause a limited change or no change in the existing assignment.

2. The entries of matrix T may be or may not be all known, which depends on channel information available in a call admission control module of a master device.

When all the entries are necessary but are not available, the unavailable entries can be estimated using historical data. For example, the unavailable entries can be estimated on the basis of previously recorded channel gains between peers over specific channels.

3. The QoS requirement of various flows are all guaranteed in the MSJA problem. More specifically, a PLR (Packet Loss Rate) requirement is first translated into the minimum BER (Bit Error Rate) threshold.

The value of tₘₙ is then calculated on the basis of the maximum physical layer transmission rate and the BER of a stream is set as the minimum BER threshold. Accordingly, the matrix T can reflect both the rate requirement and the packet loss requirement of each flow.

The delay jitter of different packets of a flow is upper-bound by the duration of a super frame because of the I DMA structure and the peak rate allocation strategy.

### <Reduced MSJA (RMSJA) Problem>

On the contrary to the original MSJA problem in which a flow can be assigned to any available channel in a subset, the RMSJA restricts the assignment of a flow to a specific subset of channels satisfying S₁⊂S. Here, M₁=|S₁| is assumed. Then, as described above, it is assumed that J is a set of flows (jobs) to be assigned to the channels. S₁ and J can be given as inputs to the problem. For example, S₁ is a set of operational channels in a system and can include the operating channels detected by the master device. J can include the jobs which are currently executed or the jobs which are currently executed and the jobs requiring the channel allocation. Similarly to the original MSJA problem, the optimal solution to the RMSJA problem can be found as follows.

The feasible assignment of a set of flows to a given channel means that the total number of slots required for the flows is not larger than the capacity of the channel. More specifically, when it is assumed that Jₘ is a job assigned to channel m and Jₘ⊂J is satisfied. Then, the assignment to channel m is feasible only when Expression 5 is satisfied.

$$\begin{matrix}Expression 5 & \\ {\sum }_{n ∈ {J}_{m}} {t}_{mn} \leq {C}_{m} & \end{matrix}$$

The channel allocation is feasible only when three conditions of Expression 6 are satisfied.

$$\begin{matrix}Expression 6 & \\ {\sum }_{n ∈ {J}_{m}} {t}_{mn} \leq {C}_{m} , ∀ m , 1 \leq m \leq {M}_{1} & ( 1 ) \\ {J}_{u} ⋂ {J}_{v} = ∅ , ∀ u , v with 1 \leq u \leq {M}_{1} , 1 \leq v \leq {M}_{1} , u \neq v & ( 2 ) \\ {\sum }_{m = 1}^{M} {J}_{m} = J & ( 3 )\end{matrix}$$

The condition of (2) means that a flow cannot be assigned to two or more servers.

Binary variable xₘ can be defined for channel m as expressed by Expression 7.

$$\begin{matrix}Expression 7 & \\ {x}_{m} \{ \begin{matrix}0 ; & if \vert Jm \vert = 0 \\ 1 ; & if \vert Jm \vert \geq 1\end{matrix} & \end{matrix}$$

Here, the minimization of the number of servers to be allocated to the jobs can be expressed by Expression 8.

$$\begin{matrix}Expression 8 & \\ minimize {\sum }_{m = 1}^{M} {x}_{m} & \end{matrix}$$

Since the optimization of the subset of channels considered in the MSJA problem is considered in the RMSJA problem, its feasible space is a subset of feasible spaces in the original MSJA problem. As a result, the optimal solution to the RMSJA problem is a sub-optimal solution to the MSJA problem.

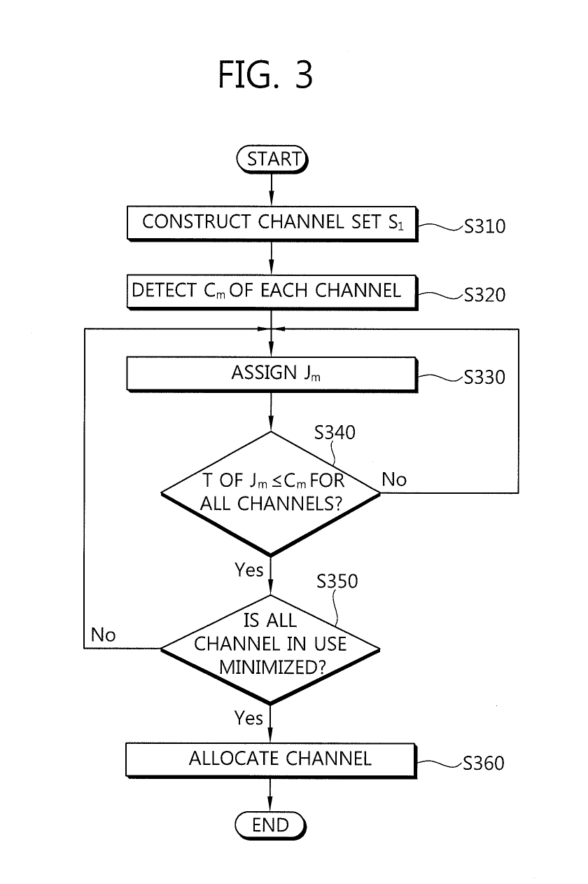

FIG. 3 is a flow diagram schematically illustrating a method of finding the optimal solution to the RMSJA problem.

In order to find the optimal solution, a batch channel allocation method (hereinafter, referred to as a “batch method”) of searching all the sets of channels given to the RMSJA problem is performed.

By performing the batch method, a specific channel set S₁ is constructed as described above (S310).

S₁ is a set of operational channels which are operating or can operate in a network.

The capacity Cₘ of channel m of S₁ is calculated (S320).

Job Jₘ is assigned to the channels of S₁ (S330). Here, all the channels to which the job is assigned should satisfy the conditions of Expression 6 (S340). When the conditions of Expression 6 are not satisfied, job Jₘ is reassigned (S330).

When the conditions of Expression 6 are satisfied, the jobs can be assigned to the channels or the channels can be allocated to the jobs in accordance with the corresponding job assignment (S360). Here, in order to more efficiently perform the radio resource management to enhance the management efficiency of the network, it can be determined whether the job assignment is a channel allocation for minimizing the total number of operating channels in accordance with Expression 8.

When it is determined that the total number of operating channels is minimized, the channels are allocated to the jobs (S360). When it is determined that the total number of operating channels is not minimized, the jobs are reassigned (S330) and the above-mentioned processes can be performed again.

### <Radio Resource Management in Feasible Mode>

The optimal solution (also referred to as “batch solution”) to the MSJA problem requires testing all of M^{N} possible channel allocations in the network. Here, M represents the total number of available channels in the network and N represents the total number of jobs. Accordingly, the finding of the optimal solution to the MSJA problem is too complex to perform in real time.

Therefore, (M₁)^{N} channel allocations can be tested to find a feasible optimal solution to the RMSJA. Here, M₁ represents the number of available channels to which the RMSJA problem is applied.

Since the (M₁)^{N} channel allocations should be tested to find the optimal solution to the RMSJA, a sub-optimal solution may be found using a sequential channel allocation method (hereinafter, referred to as “sequential method”) based on the heuristics in advance.

The sequential method has (linear) execution complexity O(M) and does not require any channel migration involved in the radio resource management (since the IU's operation is detected, a necessary channel migration is still executed).

When a new flow arrives, the sequential method is performed. This method constructs a new channel allocation over the existing allocation (that is, is performed without any change in channel allocation to ongoing flows).

The sequential method has a low complexity and can be easily performed, but may not be satisfactory, compared with the batch method of performing an exhaustive search, in terms of the number of channels allocated. However, since the allocation of a new channel can be accomplished by extending the existing allocation, all the possible channel allocations do not have to be tested to find a solution.

Therefore, the channel allocation in the multi-channel cognitive radio network may be carried out using the sequential method of almost optimizing the feasible RMSJA problem.

The channel allocation in the multi-channel cognitive radio network may be carried out using the batch method of optimizing the feasible RMSJA problem.

The channel allocation in the multi-channel cognitive radio network may be carried out by combination of the sequential method and the batch method.

### <RMSJA-Based CAC (Call Admission Control)>

The solution of the RMSJA problem can be found on the basis of the following three factors: resource consumption matrix T, set of flows J, and set of channels S₁ to be allocated.

The time of allocating channels by solving the RMSJA problem can be set to one of the following two times depending on when the master device should perform the radio resource management.

Arrival of New Flow

When a request for a new flow (stream) arrives (hereinafter, referred to as “arrival of a new flow”), the master device performs the call admission control (CAC) process to determine the resources (channels and MASs) to be allocated to the new flow.

In this case, J includes all the ongoing flows and the incoming flow requiring the admission.

First, S₁ includes all the operating channels used in an underlying subnet. The matrix T is accordingly calculated by the master device.

Then, the master device performs a batch method, for example, a tree-based search method to be described later, to find a feasible channel allocation.

When any feasible allocation is not found in the current set of channels, S₁ is extended to include the best channel in the backup list. When S₁ is extended, T is modified to reflect the newly-included channel. Therefore, a modified RMSJA problem is constructed.

A feasible solution to this new problem is necessarily found. This is because the feasible solution can be constructed as follows: the incoming flow is assigned to the new channel without changing the channel allocation to all the ongoing flows.

The tree-based search method is carried out to obtain the channel allocation optimized for the RMSJA problem. In this case, channel migration may be required. The channel migration can be performed by the master device.

End of Ongoing Flows

When the existing flows are ended, the MASs in the channel are free. If theses free MASs are not harvested, fragmented segments of the free MASs are created over a lot of channels, thereby leading to the unnecessary over-allocation of channels (that the number of channels allocated to the ongoing flows is greater than the minimum number of channels needed).

In order to solve the over-allocation of channels, the radio resource management module, that is, the batch method, is executed at the time of end of a stream, whereby the free MASs are gathered in several channels.

When a flow is ended, the solution to the RMSJA problem is found using the set S₁ including all the operating channels just before the flow is ended.

The set J includes all the existing flows (other than the ended flow). The matrix T is calculated using S₁ and J.

Then, the master device can execute the tree-based search method to obtain the channel allocation optimized for the RMSJA problem. Here, the channel migration may be required depending on the channel allocation and the free channels are returned to the channel backup list for the corresponding subnet.

### <Solution to RMSJA Problem>

Exhaustive Search Method (Batch Method)

The classic MSJA problem is NP-hard (Nondeterministic Polynomial-time—hard). Since the RMSJA problem has the same structure as the MSJA problem, the RMSJA problem is also NP-hard.

However, since the RMSJA problem includes a larger number of channels (which is larger by one than the number of channels in the set of operating channels at most), the RMSJA problem can be more easily treated in terms of calculation and execution. Therefore, when J and S₁ are relatively small, The exhaustive search method, that is, the batch channel allocation method, can be used to solve the RMSJA problem.

In order to apply the exhaustive search method, that is, the batch channel allocation method, to the RMSJA problem, a set of channel allocations (in combination, (M₁)^{N} allocations exist) is sequentially searched. All the channel allocations are tested for the feasibility conditions of Expression 6.

When an allocation is feasible, an objective function is evaluated by the use of Expression 8. The optimal allocation is a feasible allocation minimizing the objective function.

When one or more feasible allocations minimize the objective function, the allocation having the minimum total power consumption can be selected.

Here, the following two remarks should be noted.

1. The optimal solution (solution found using the batch method) to the RMJSA problem may not be the optimal solution to the MSJA problem. This is because the exhaustive search approach for the RMSJA problem considers (M₁)^{N} allocations, but the exhaustive search approach or the MSJA problem considers M^{N} allocations.

However, under an ideal condition (without any change in channel and any change in interference from other subnets), two solutions are likely to be identical. Under this condition, this is because the channels considered in the RMSJA problem are the base available channels (The RMSJA problem first uses the highest channel in the backup list and then uses a subsequent channel).

2. The execution complexity of the exhaustive search method is equal to the worst complexity. This is because all the possible combinations should be searched.

Sub-Optimal Solution (Sequential Method)

It is not easy to actually implement the optimal solution to the RMSJA problem. The computational complexity that (M₁)^{N} channel allocations should be tested still exists.

When the optimal solution is found using the batch channel allocation method, the channel allocation to the overall jobs (flows) should be considered, whereby the existing channel allocation may be changed. Accordingly, whenever a new flow is admitted, the channel migration may be performed, which imposing a burden on the network management.

A method of finding a sub-optimal solution having excellent performance but less channel migration can be considered instead of the optimal solution.

For example, the sub-optimal solution can be found with the computational (linear) complexity of O(M) through the use of an MIOM (Minimum Increment of Occupied MASs) algorithm described below.

C⁰ represents a set of operating channels that are currently used (fully or partially) by the ongoing streams of the underlying small-power CR network subnet. C⁰ is a subset of C (C⁰⊂C).

T^{(k)} represents the number of unused MASs over channel k(kεC).

In the MIOM algorithm, incoming flow n satisfying tₘₙ=min{tₖₙ|kεC⁰, T^{(k)}≧tₖₙ} is assigned to channel m.

As described above, tₘₙ represents the minimum number of MASs necessary for satisfying the rate requirement of flow n over channel k at the time of using the best possible transmission rate (where the transmission power is set to the maximum value subjected to a known power mask constraint).

When the set {kεC⁰, T^{(k)}≦tₖₙ} is an empty set, the incoming flow is assigned to a new channel supporting the highest rate (the minimum number of MASs) among all the channels in C-C⁰.

In this algorithm, it should be noted that the incoming flow is always assigned to a channel supporting the highest possible rate for the flow. In the sequential method, it is first considered whether the channel allocation is possible within the set of channels partially used.

When there is no channel supporting the rate requirement of a new flow, a selection process is performed on the remaining set of channels.

The concept of the MIOM algorithm is that fewer operational channels per subnet are allocated by searching for a channel in which the minimum number of MASs are allocated to a prospective flow (that is, the best feasible channel). This lowers the blocking probability for a new request and allows more idle channels to be available in other subnets (which positively contributes to the coexistence between the neighboring subnets).

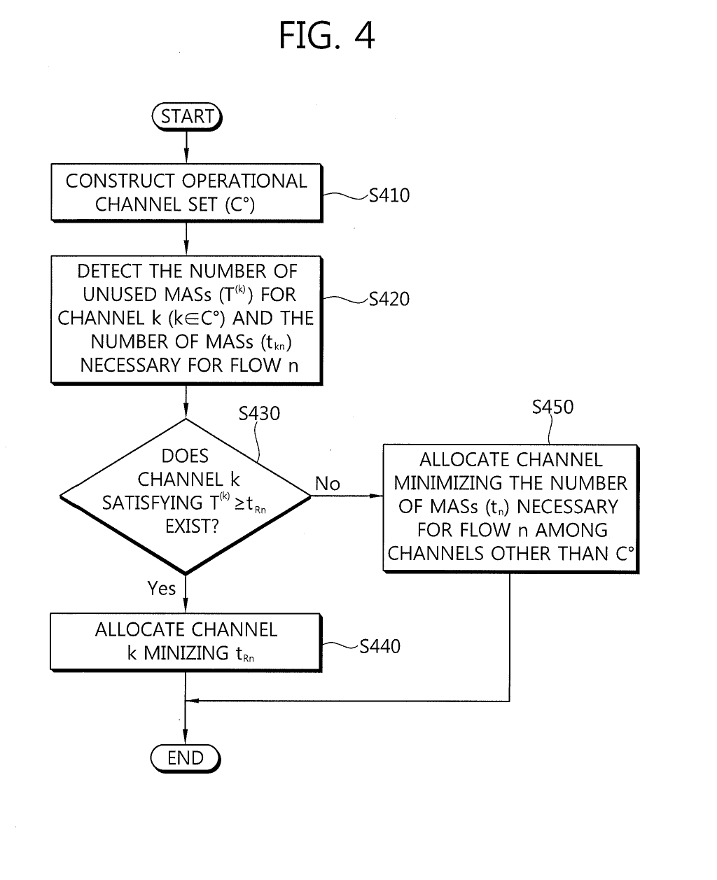

FIG. 4 is a flow diagram schematically illustrating the sequential channel allocation method.

When the sequential method is executed, a set of operational channels C⁰ in the current network is first constructed (S410).

The number of unused MASs T^{(k)} over channel k belonging to the set C⁰ and the number of MASs tₖₙ necessary for channel k for processing flown requesting for the channel allocation are calculated (S420).

Then, it is determined whether channel k satisfying the condition of kεC⁰, T^{(k)}≧tₖₙ exists (S430) and the channel is allocated. At this time, when plural channels satisfy this condition kεC⁰, T^{(k)}÷tₖₙ, the channel requiring the minimum number of MASs for processing flown among the channels is allocated to flown (S440).

When it is determined that channel k satisfying kεC⁰, T^{(k)}≧tₖₙ does not exist, the channel requiring the minimum number of MASs for processing flow n among the other channels is allocated to flow n (S450). In this case, the number of unused MAS in the allocated channel should be larger than the number of MASs necessary for processing flown.

Combination of Sequential Method and Batch Method

On the contrary to the sequential radio resource management method, that is, the sequential method, all the possibility in the set S₁ is examined to determine the optimal assignment over the set S₁ in the batch radio resource management method, that is, the batch method, for the RMSJA problem.

The disadvantage of the batch method is the complexity, which exponentially increases depending on the number of flows and the number of channels. Therefore, by combining the sequential method and the batch method so as to obtain the minimum number of channels without frequently executing the batch method, it is possible to reduce the execution complexity and to enhance the performance of the radio resource management method.

The potential advantage of the batch method when a flow arrives and the flow is ended will be described.

When a new flow arrives, the batch method is executed by at most two steps. (1) S₁={all operating channels} and J={existing flows+new flow} are set to solve the RMSJA problem. (2) When the feasible solution is not found in step (1), a channel is added to update S₁ and the updated RMSJA is solved.

When M₁ is defined as the size of S₁ in step (1), it is apparent that the optimal solution to the RMSJA problem is involved in M₁ or M₁+1 channels. That is, when a certain sequential approach is applied to the same setting, the solution is obtained using the M₁ or M₁+1 channels.

Since the batch method examines more combinations than the sequential method at the time of constructing a new allocation, the number of channels required for the sequential method is not smaller than the number of channels required for the batch method.

Accordingly, in terms of the number of necessary channels, the performance gain in the batch method is obtained only when the batch method employs M₁ channels and the sequential method uses M₁+1 channels.

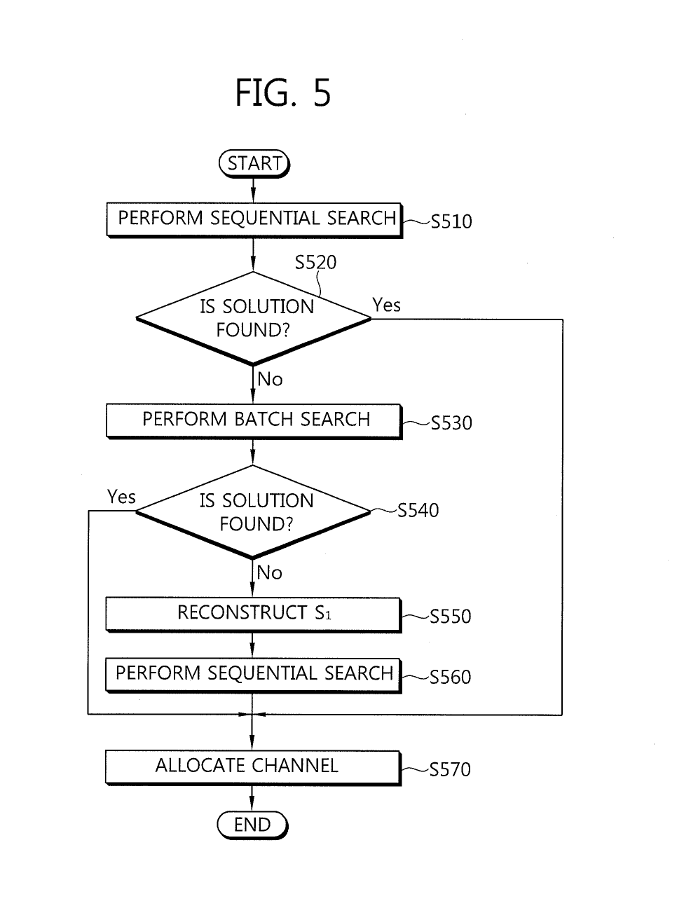

In consideration of this description, the sequential method and the batch method can be combined so as to reduce the frequent execution of the batch method without lowering the performance. FIG. 5 is a flow diagram schematically illustrating the channel allocation method in which the sequential method and the batch method are combined.

When a new flow arrives, the sequential method is first executed on the current set of operational channels (S510). When a solution can be found using the sequential method, the channels are allocated in accordance with the found solution (S520). In this case, the batch method need not be executed because the same solution is found.

On the contrary, when a feasible solution is not found using the sequential method, the RMSJA problem is constructed by S₁={all operating channels} and J={existing flows+new flow} and the batch method is executed on the problem (S530). When a feasible solution is found using the batch method, the found solution can be used for the channel allocation (S540).

When a feasible solution is not found, the sequential method is executed again (S560). At this time, the sequential method is executed on the set of channels in which the uppermost channel in the backup list is added to the operational channels (S550). By using the updated set of channels, a feasible solution to be used for the channel allocation can be found using the sequential method (S570). In this case, it should be noted that the batch method need not be executed on the updated set of channels, because the same solution will be found.

Reduction of Execution Complexity at the time of End of Flow When the batch method is executed at the time of end of an existing flow, it contributes to gathering the free MASs in several channels, which leads to releasing the operating channels.

When the batch method is executed at the time of end of a flow, it may not always lead to release the channels. The channels are released when the total number of unused MASs over all operating channels is equal to or greater than the channel capacity.

Accordingly, it can be considered that the batch method is selectively executed at the time of end of a flow, which can greatly reduce the execution overhead by avoiding unnecessary channel migration. Whenever the batch method is executed after the end of a flow, the channels are returned to the backup list. Therefore, the performance is not lowered.

Tree-based Search Method with Low Complexity and High Throughput

A tree-based search method can be used as an example of the batch method for exhaustive search.

The key to the tree-based search method is to pre-order the set of channel allocations so as to avoid unnecessary examination of certain allocations causing infeasible solutions.

Essentially, the (M₁)^{N} combinations of the batch method for the RMSJA problem are pre-ordered so that some combinations dominate other combinations in the sense that if first combinations are infeasible, the other combinations are infeasible and thus need not be examined. This pre-ordering greatly reduces the computational complexity of the batch method.

The technical concept is algorithmically implemented herein. In the tree-based search method, possible flow-channel assignments are searched so as to determine the optimal assignment (for the RMSJA problem) for a relatively short time. A data structure used in the tree-based search method will be first described below. Then, the tree-based method will be described in detail.

Tree-Based Representation of RMSJA Problem

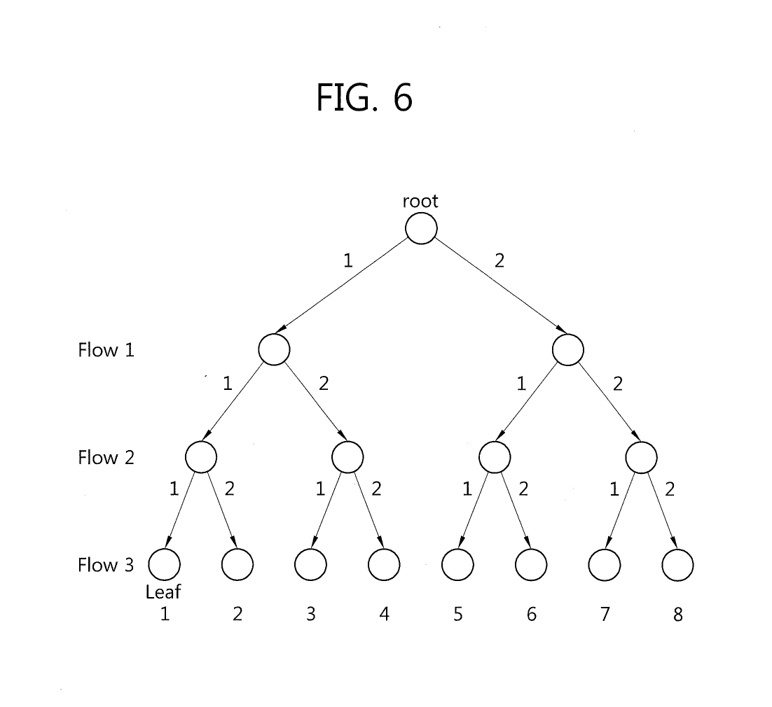

The RMSJA problem is considered. FIG. 6 is a diagram schematically illustrating a tree structure used in the batch channel allocation method according to the invention. All possible channel allocations can be presented by a tree R shown in FIG. 6. The height of the tree represents the number of flows N in the set J. Each node in the tree other than leaf nodes has M₁ child nodes (outgoing edges). The nodes at height i correspond to i-th flow in J and the edges originating from the nodes represent M₁ possible channel allocations for the flow.

In the tree R, a unique path from a root node to a leaf node represents a complete channel allocation for N flows.

In the example shown in FIG. 6 with three flows and two channels, the tree R includes eight leaf nodes denoted by 1, 2, . . . , and 8. The labels of the outgoing edges of each node in the tree R represent two channels which can be allocated to the corresponding flow.

The path from the root node to leaf node 1 is labeled by (1, 1, 1), which corresponds to the allocation of channel 1 to three flows.

Similarly, the other possible allocations presented by leaf nodes 2 to leaf nodes 8 are (1, 1, 2), (1, 2, 1), (1, 2, 2), (2, 1, 1), (2, 1, 2), (2, 2, 1), and (2, 2, 2). This tree-based representation includes all possible channel allocations for J and S₁.

Tree-Based CAC and RRM at the Time of Arrival of Flow

In a typical subnet, all devices are likely to observe similar interference conditions for a given channel. This is attributed to the small size of a subnet and the TDMA characteristic of intra-subnet transmissions. Therefore, the interference floors of various channels in a subnet can be taken on the basis of the measurements of the master device.

The set of operating channels is labeled in an increasing order of the interference floors, as measured by the master device.

The ongoing flows are labeled in a decreasing order of the required MASs on the basis of the channels currently allocated thereto.

The particular channel labeling ensures that a channel allocation including good channels, that is, including a smaller interference floor will be first tested. On the other hand, it is also ensured that the flows requiring a larger number of MASs will be first examined in a given channel allocation.

The purpose of two types of labeling is to preorder the set of channel allocations in the tree, to search for feasible channel allocations, and reduce the number of channel migrations generated when it is necessary to reshuffle the flows over various channels.

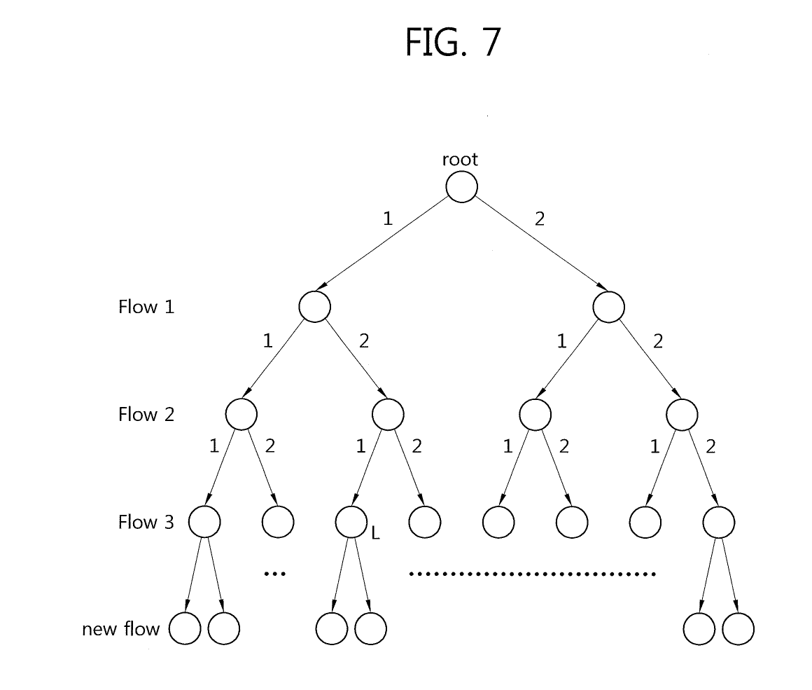

FIG. 7 is a diagram schematically illustrating the tree structure when a new flow requests to join a subnet. A particular leaf node in the tree R represents the current channel allocation based on L. When a new flow f requests to join the subnet at a certain instance, the master device defines J′=J+{f} and S′=S₁ to execute the CAC and constructs a new RMSJA.

The tree R′ represents a new RMSJA problem which can be constructed from the previous tree R by the use of the following method.

The height of the tree R increases by 1 and (M₁)^{N+1} nodes are added as the leaf nodes of R. The new leaf nodes are the leaf nodes of R′. The leaf nodes of R are connected to the M₁ leaf nodes of R′ and thus become internal nodes in R′. The construction of R′ from R is shown in FIG. 7.

In order to determine a feasible channel allocation in R′, it is necessary to tour the leaf nodes of R′ until a feasible channel allocation is found.

When no feasible leaf node is found, it can be determined that the current RMSJA problem is infeasible. In this case, the uppermost channel in the backup channel list is added to S₁. The resultant problem must be feasible, as described above.

The most time-consuming step in the above-mentioned procedure is the step of touring the leaf nodes of R′. This touring continues until a feasible node is found or until all leaf nodes are visited.

The following observations are presented for the tree touring method.

1. For an internal node (not a leaf node) in R′, when a partial channel allocation presented by a path from the root node to node n is infeasible, any complete channel allocation obtained from this partial channel allocation is infeasible (see Table 1). In this case, all sub-trees originating from node n should be excluded from the subsequent exploring.

2. When it is determined that the existing channel allocation (presented by the path from the root node to node L in FIG. 7) is feasible, node L can be set as a start point of the touring of R′. In order to minimize the number of flows to move, the leaf nodes of R′ having the largest number of common edges with the path from the root node to node L are explored.

On the basis of the above observations, the nodes of R′ are explored from node L in R′ using the algorithm shown in Table 1.

TABLE 1

| Initialization | Set var_root | var_root represents node in R′ to be explored. |
|---|---|---|
| Step 1 | Examine sub-path in R′ from root node to var_root | |
| | Prune sub-trees originating from var_root if sub-path is infeasible | |
| | Set var_root | node after var_root in pruned tree in |
| | | accordance with specified pre-order |
| | repeat Step 1 until sub-path from root node to var_root is feasible | |
| Step 2 | Tour leftmost sub-tree of var_root | |
| | Return corresponding path and end touring if feasible leaf node is | |
| | found | |
| Step 3 | Tour next sub-tree on right side of var_root | |
| | Return corresponding path and end touring if feasible leaf node is | |
| | found | |
| Step 4 | Set var_root if a feasible leaf node is not found in steps 2 and 3 | node following var_root in tree in accordance |
| | | with specified pre-order |
| | Perform step 1 again | |
| Step 5 | End touring when all leaf nodes in R′ are explored and a feasible | |
| | leaf node is not found | |

In the above-mentioned pre-ordering, the “feasible leaf node” means such a leaf node that the path from the root node to the corresponding node presents a feasible channel allocation.

The “exploring a node” means to check the feasibility of the partial channel allocation from the root node of R′ to the corresponding node.

The above-mentioned search procedure can rapidly perform a process of finding a feasible allocation and reduce the number of channel migrations caused by reshuffling the flows.

More specifically, whenever a sub-channel allocation (identified by a node on the tree) is determined as being infeasible, the entire sub-trees originating from the corresponding node are excluded from the subsequent exploring.

Accordingly, the search space can be greatly reduced. This search method attempts to first explore channels of lower interference floors, because such channels are more likely to accommodate the new flow and lead to a feasible allocation.

At the same time, when a channel migration is necessary, this method first changes the channel of the relatively “light” flow. This flow occupies a smaller number of MASs and a smaller number of MASs are involved in the channel migration.

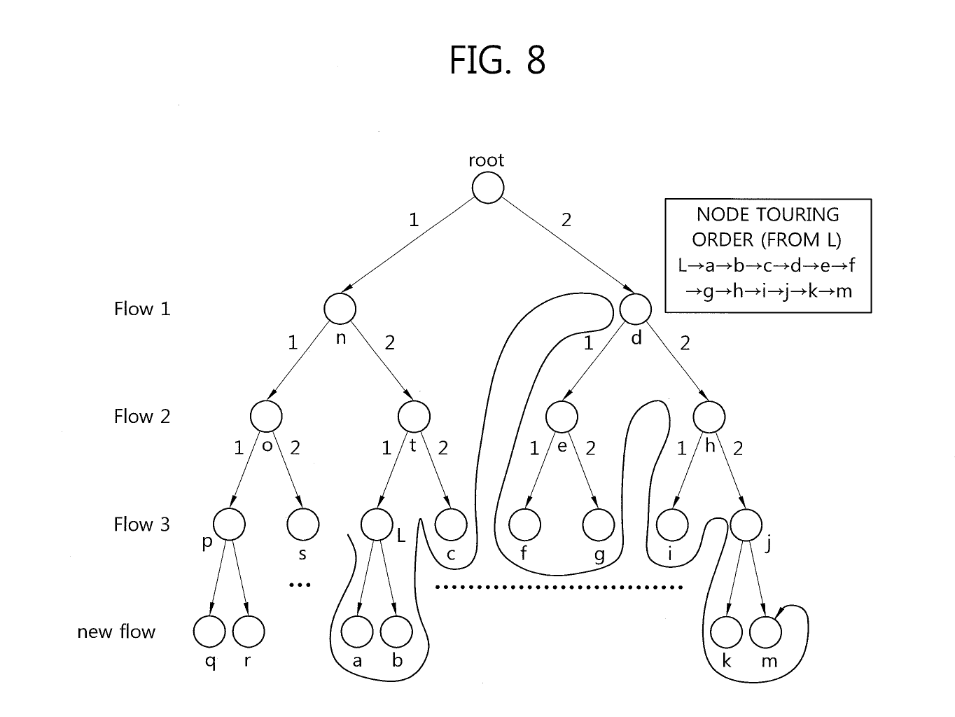

An example of the exploration procedure is shown in FIG. 8. FIG. 8 is a diagram schematically illustrating a method of touring the tree structure including a new flow. In the example, node L represents the current channel allocation of three flows over two channels.

This allocation is given by the path (1, 2, 1), which represents that flow 1 is assigned to channel 1, flow 2 is assigned to channel 2, and flow 3 is assigned to channel 1.

The channels are pre-ordered from the best channel to the worst channel (that is, channel 1 is the best which is represented by the leftmost branch of each node in the tree).

The ongoing flows are labeled in the decreasing order of their demands, where flow 1 represents the highest-demand flow (nodes just below the root node) and flow 3 represents the lowest-demand flow (leaf nodes of the original tree R).

The exploring is started from node L according to the above-mentioned exploring procedure. The child nodes (node a and node b) of node L are explored from the leftmost child node.

When it is determined that the child node is infeasible, the procedure moves to the next node to the right. When it is determined that all the child nodes are infeasible, the procedure goes to a higher level and explores the right node (node c) of node L originating from the same parent node (node t).

In this example, it is assumed that node c is infeasible, that is, that the partial allocation (given as a sub-path (1, 2, 2)) from the root node to node c is infeasible. Accordingly, the sub-trees originating from the node c are not explored any more.

Here, it is assumed that all the child nodes of node t have been explored. Then, since node t is the rightmost child node of node n, the procedure moves to the next node on the right side, that, node d, and the feasibility of node d (that is, whether flow 1 is supported by channel 2) is checked. When it is assumed that node d is feasible, the leftmost child node (node e) of node d is explored. When it is determined that the child node is feasible, the feasibility of the child nodes of node e is checked.

When it is determined that both child nodes are infeasible, the procedure sequentially moves to and explores node h, node i, and node j.

In the worst case, all leaf nodes of R′ should be toured before the procedure is ended in the invention. Accordingly, the worst complexity is still O(M₁^{N+1}). However, in the best case, only one child node of node L may be toured.

Therefore, the best complexity is O(1) which is the same as the complexity of the sequential method. The actual (average) complexity lies somewhere between two limits. The tree-based search method provides a unified RRM approach in which the sequential method and the batch method are combined.

The pre-ordering of channel allocations ensures that a search of high cost will be performed only when no feasible leaf node is found in a search of low cost.

Among all the feasible allocations, the returned allocation has the minimum difference from the previous allocation, whereby the number of channel migrations is minimized.

Tree-Based RRM at the Time of End of Flow

It is assumed that ongoing flow f finishes its transmission over a given channel and leaves the subnet.

When f is the only flow operating in the channel, the channel is simply released and returned to the backup list. When other flows operate in the channel, the RMSJA problem may be constructed depending on the total number of free MASs and may be solved to release and return the operating channel to the backup list.

The RMSJA can be defined using J′ and S′: J′=J−{f′} and S′=S1−{channel in S₁ with the larges interference floor}. One of the following two options can be executed to obtain a feasible channel allocation.

Option 1: The RMSJA tree defined by (J′, S′) is toured to find a feasible channel allocation. In this case, a start root node (var root) for search is an actual root node in the tree.

Option 2: Jᵥ={flows operating in the channel in S₁ with the largest interference floor} is defined. The flows of are processed as new flows requesting to join the existing system defined by {J′−Jᵥ, S′}. Accordingly, the tree-based search method introduced previously is sequentially executed on the set J, (a flow admitted at a time) to find the feasible solution to the RMSJA problem defined by {J′, S′}.

Compared with option 1, option 2 has an advantage of requiring a smaller number of channel migrations for the remaining flows.

In the description of the invention, the jobs through a communication network can be performed by a system (for example, server) managing the communication network in the course of controlling the network and transmitting data, or can be performed by a terminal coupled to the network.

In addition, the description, “including a specific configuration”, in the invention means that it does not exclude any configuration other than the specific configuration but any additional configuration may be included in the embodiments of the invention or the technical spirit of the invention.

Although methods have been described as a series of steps or blocks with reference to the flowcharts in the above-mentioned system, the invention is not limited to the sequence of steps but a certain step may be performed at different times from or at the same time as another step. It will be understood by a person skilled in the art that the steps shown in the flowcharts are not exhaustive but may include another step, or one or more steps in the flowcharts can be deleted without affecting the scope of the invention.

The above-mentioned embodiments may include various modifications. All possible combinations of the modifications cannot be described, but it will be understood by a person skilled in the art that other combinations may be possible. Therefore, it should be understood that the invention includes all alternations, modifications, and changes belonging to the appended claims.

What is claimed is:

1. A sequential channel allocation method in a multi-channel cognitive radio network, comprising the steps of
detecting operational channels in the network and constructing an operational channel set;
detecting the number of unused unit radio resources and the number of unit radio resources necessary for processing a job for each channel of the operational channel set; and
assigning the job to the channel in which the number of unused unit radio resources is equal to the number of unit radio resources necessary for processing the job or the number of unused unit radio resources is greater than the number of unit radio resources necessary for processing the job among the channels of the operational channel set.

2. The sequential channel allocation method according to claim 1, wherein when the number of unused unit radio resources is equal to the number of unit radio resources necessary for processing the job or the number of unused unit radio resources is greater than the number of unit radio resources necessary for processing the job in the plurality of channels of the operational channel set, the job is assigned to the channel in which the number of unit radio resources necessary for processing the job is minimized among the plurality of channels.

3. The sequential channel allocation method according to claim 1, wherein when a channel in which the number of unused unit radio resources is equal to the number of unit radio resources necessary for processing the job or the number of unused unit radio resources is greater than the number of unit radio resources necessary for processing the job does not exist in the operational channel set, the job is allocated to a channel in which the number of unused unit radio resources is equal to the number of unit radio resources necessary for processing the job or the number of unused unit radio resources is greater than the number of unit radio resources necessary for processing the job among channels other than the operational channel set.

4. The sequential channel allocation method according to claim 1, wherein when the number of unused unit radio resources is equal to the number of unit radio resources necessary for processing the job or the number of unused unit radio resources is greater than the number of unit radio resources necessary for processing the job in a plurality of channels other than the operational channel set, the job is assigned to the channel in which the number of unit radio resources necessary for processing the job is minimized among the plurality of channels.

5. The sequential channel allocation method according to claim 1, wherein the unit radio resources are media access slots (MASs).

6. A batch channel allocation method in a multi-channel cognitive radio network, comprising the steps of
constructing a predetermined channel set;
detecting a capacity of each channel of the channel set;
assigning jobs requiring a channel allocation to the channels of the channel set;
determining whether a channel to which the jobs are assigned more than the capacity of the channel exists for all the channels of the channel set; and
performing the step of assigning the jobs to the channels and the subsequent steps again when it is determined that a channel to which the jobs are assigned more than the capacity of the channel exists, and allocating the channels in accordance with the job assignment when it is determined that a channel to which the jobs are assigned more than the capacity of the channel does not exist.

7. The batch channel allocation method according to claim 6, wherein the channel set is a set of operational channels in the network.

8. The batch channel allocation method according to claim 6, wherein the step of determining whether a channel to which the jobs are assigned more than the capacity of the channel exists includes determining whether an amount of radio resources necessary for processing the total jobs and assigned to the channels of the channel set is greater than an amount of available radio resources.

9. The batch channel allocation method according to claim 8, wherein the radio resources are media access slots (MASs).

10. The batch channel allocation method according to claim 6, further comprising a step of determining whether the assignment minimizes the number of channels in use of the channel set when it is determined that a channel to which the jobs are assigned more than the capacity of the channel does not exist,
wherein the channels are allocated in accordance with the job assignment when it is determined the assignment minimizes the number of channels in use, and the step of assigning the jobs to the channels and the subsequent steps are performed again when it is determined that the assignment does not minimize the number of channels in use.

11. The batch channel allocation method according to claim 6, wherein the batch channel allocation method in the multi-channel cognitive radio network is performed when a request to allocate a channel to a job is received.

12. The batch channel allocation method according to claim 6, wherein the batch channel allocation method in the multi-channel cognitive radio network is performed when a job in process is finished.

13. The batch channel allocation method according to claim 6, wherein the assignment of the jobs to the channels of the channel set is performed using a tree structure,
wherein the tree structure is constructed so that the height of the tree structure corresponds to the number of jobs requiring the channel allocation, nodes located at the same height in the tree structure correspond to the same job out of the jobs requiring the channel allocation, and edges of the tree structure correspond to the channels which can be allocated to the jobs corresponding to the nodes from which the edges originate among the channels of the channel set, and
wherein it is determined whether the channel allocation is feasible from the top to the bottom and from the left to the right in the tree structure.

14. The batch channel allocation method according to claim 13, wherein the leftmost edge of the edges branched from a specific node in the tree structure corresponds to the channel with the best channel quality and the higher nodes of the nodes in the tree structure correspond to the jobs requiring a smaller amount of radio resources.

15. The batch channel allocation method according to claim 13, wherein when the channel allocation to a new job is requested, new leaf nodes of the tree structure are constructed by the nodes corresponding to the new job, and
wherein when an existing channel allocation is currently feasible, a search is started from the node corresponding to the current channel allocation and a new channel allocation is set up.

16. The batch channel allocation method according to claim 15, wherein when a new channel allocation is not set up, a new channel is added to the channel set to reconstruct the edges of the tree structure and the new channel allocation is set up in the reconstructed tree structure.

17. A channel allocation method in a multi-channel cognitive radio network, comprising the steps of
detecting operational channels in the network and constructing an operation channel set;
performing a sequential channel allocation on a necessary job requiring a channel allocation using the channels of the operational channel set; and
performing a batch channel allocation on the overall jobs including the necessary job using the channels of the operational channel set when the channel to be allocated to the necessary job is not searched for by the sequential channel allocation,
wherein the sequential channel allocation includes the steps of
determining whether the necessary job exceeds the capacity of the channel to be allocated to the necessary job for each channel of the operational channel set; and
determining that the channel to be allocated to the necessary job is not searched for when it is determined that a channel in which the necessary job does not exceed the capacity of the channel does not exist in the channels of the operational channel set, and assigning the necessary job to an available channel when the available channel in which the necessary job does not exceed the capacity exists, and
wherein the batch channel allocation includes the steps of
detecting the capacity of each channel of the operational channel set;
assigning the overall jobs including the necessary job to the channels of the operational channel set and determining whether a channel to which the jobs are assigned more than the capacity of the channel exists; and
performing the step of assigning the jobs to the channels and the subsequent steps again when it is determined that the channel to which the jobs are assigned more than the capacity of the channel exists, and allocating the channels in accordance with the job assignment when it is determined that the channel to which the jobs are assigned more than the capacity of the channel does not exist.

18. The channel allocation method according to claim 17, wherein when the channels to which the overall jobs should be assigned are not set up by the batch channel allocation, a new channel is added to the operational channel set and the sequential channel allocation is performed on the necessary job.

19. The channel allocation method according to claim 17, wherein when two or more available channels exist at the time of performing the sequential channel allocation, the necessary job is assigned to the channel requiring the smallest amount of radio resources for processing the necessary job among the two or more available channels.

20. The channel allocation method according to claim 17, further comprising a step of determining whether the job assignment minimizes the number of channels in use among the channels of the channel set when the channel to which the jobs are assigned more than the capacity of the channel does not exist at the time of performing the back channel allocation,
wherein the channel is allocated in accordance with the job assignment when it is determined that the job assignment minimizes the number of channels in use, and the step of assigning the overall jobs to the channels and determining whether a channel to which the jobs are assigned more than the capacity of the channel exists and the subsequent steps are performed again when it is determined that the job assignment does not minimize the number of channels in use.
